(19) United States
(12) Patent Application Publication
(10) Pub. No.: US 2018/0283171 A1
(43) Pub. Date: Oct. 4, 2018

(54) System And Method For Optical Communication Using Optical Switches

(71) Applicant: Halliburton Energy Services, Inc, Houston, TX (US)

(72) Inventors: Satyan Gopal BHONGALE, Cypress, TX (US); Yenny Natali MARTINEZ, Houston, TX (US)

(73) Assignee: Halliburton Energy Services, Inc, Houston, TX (US)

(21) Appl. No.: 15/519,385

(22) PCT Filed: Dec. 22, 2015
(86) PCT No.: PCT/US2015/067333

§ 371 Date: Apr. 14, 2017

(51) Int. Cl. E21B 47/12; H04Q 11/00; E21B 49/08; E21B 49/00; E21B 47/00; E21B 47/06; E21B 47/10

(52) U.S. Cl. CPC E21B 47/123; H04Q 11/0003; E21B 49/08; E21B 49/00; E21B 2049/085; E21B 47/065; E21B 47/0006; E21B 47/10; E21B 47/00

(57) ABSTRACT

An optical communication system with optical switches is described. Embodiments of an optical communication system with optical switches include a light source, a plurality of downhole optical devices communicatively coupled to the light source via an optical transmission network, and at least one optical switch disposed within the optical transmission network, the at least one optical switch switchably distributing light from the light source among the plurality of downhole optical devices.

### TECHNICAL FIELD

The present disclosure generally relates to systems and methods for optical communications and sensing. The present disclosure specifically relates to systems and methods for optical communication and sensing using optical switches.

### BACKGROUND

In recent years, techniques for communicating, sensing, and processing information using optical signals have been developed for applications in the oil and gas industry. Optical waveguides may be used to transmit data between surface equipment and downhole tools. Likewise, optical sensors may be used to measure a variety of fluid properties, geological properties, acoustic, seismic, electromagnetic, in downhole or surface equipment. Modulators and transducers may be used to write sensing information and data on the light that is transmitted via optical waveguides and/or optical fibers. At the receiver the detectors, demodulators, interferometers may be used to extract the sensing information and data.

In general, an optical sensor is a device configured to receive an input of information (such as, but not limited to, electromagnetic radiation from a sample) and produce an output of information, wherein the output reflects the measured property as an intensity, frequency or phase of the optical signal. Optical devices may be configured to receive one or more inputs of optical light, and then modulate the light to reflect the physical property measured (for example, the intensity of electromagnetic radiation); the resulting optical signals at the output may be transmitted via optical waveguides/optical fibers to a remote receiver, where the light is detected and the measured physical properties extracted. Optical sensors can also utilize optical elements to perform calculations, as opposed to the hardwired circuits of conventional electronic processors. The optical device may be, for example, an integrated computational element (“ICE”). One type of ICE is a thin film optical interference device, also known as a multivariate optical element (“MOE”). When light from a light source interacts with a substance, unique physical and chemical information about the substance is encoded in the electromagnetic radiation that is reflected from, transmitted through, or radiated from the sample. Thus, the optical sensor, through use of the ICE and one or more detectors, is capable of extracting the information of one or multiple characteristics/analytes within a substance and converting that information into a detectable output signal reflecting the overall properties of a sample. Such characteristics may include, for example, the presence of certain elements, compositions, fluid phases, and the like existing within the substance. Thus, it would be desirable to provide improved techniques for communicating with, transmitting information to, and receiving information from optical elements such as optical sensors.

### BRIEF DESCRIPTION OF THE DRAWINGS

Various embodiments of the present disclosure will be understood more fully from the detailed description given below and from the accompanying drawings of various embodiments of the disclosure. In the drawings, like reference numbers may indicate identical or functionally similar elements.

FIG. 1 is a plan view of a land based drilling system incorporating an optical communication and sensing system of the disclosure.

FIG. 2 is a plan view of a marine based production system having an optical communication and sensing system of the disclosure.

FIGS. 3a-d are plan views of an optical communication and sensing system arranged in various topologies of the disclosure.

FIG. 4 is a plan view of an optical switch of the disclosure.

FIG. 5 is a plan view of a control module of the disclosure.

FIG. 6 is a flowchart of a method of optical communication and sensing using optical switching.

FIG. 7 is a block diagram of a computer of an EM telemetry system of the disclosure.

### DETAILED DESCRIPTION

The disclosure may repeat reference numerals and/or letters in the various examples or figures. This repetition is for the purpose of simplicity and clarity and does not in itself dictate a relationship between the various embodiments and/or configurations discussed. Further, spatially relative terms, such as beneath, below, lower, above, upper, uphole, downhole, upstream, downstream, and the like, may be used herein for ease of description to describe one element or feature's relationship to another element(s) or feature(s) as illustrated, the upward direction being toward the top of the corresponding figure and the downward direction being toward the bottom of the corresponding figure, the uphole direction being toward the surface of the wellbore, the downhole direction being toward the toe of the wellbore. Unless otherwise stated, the spatially relative terms are intended to encompass different orientations of the apparatus in use or operation in addition to the orientation depicted in the figures. For example, if an apparatus in the figures is turned over, elements described as being “below” or “beneath” other elements or features would then be oriented “above” the other elements or features. Thus, the exemplary term “below” can encompass both an orientation of above and below. The apparatus may be otherwise oriented (rotated 90 degrees or at other orientations) and the spatially relative descriptors used herein may likewise be interpreted accordingly.

Moreover even though a figure may depict a horizontal wellbore or a vertical wellbore, unless indicated otherwise, it should be understood by those skilled in the art that the apparatus according to the present disclosure is equally well suited for use in wellbores having other orientations including vertical wellbores, slanted wellbores, multilateral wellbores or the like. Likewise, unless otherwise noted, even though a figure may depict an onshore operation, it should be understood by those skilled in the art that the apparatus according to the present disclosure is equally well suited for use in offshore operations and vice-versa. Further, unless otherwise noted, even though a figure may depict a cased hole, it should be understood by those skilled in the art that the apparatus according to the present disclosure is equally well suited for use in open-hole operations.

Generally, in one or more embodiments, an optical communication and sensing system is provided wherein optical switches are used to improve the signal-to-noise ratio (SNR) of information-bearing signals transmitted and received over an optical transmission network during drilling, logging-while-drilling (LWD), measurement-while-drilling (MWD), production or other downhole operations. The optical transmission network may couple a plurality of optical devices (e.g., over 100 optical devices) disposed in a wellbore to a light source(s) and/or detector(s). When a particular optical device or group of optical devices among the plurality of optical devices is selected, one or more optical switches of the optical transmission network are directed to route light from the light source(s) towards the particular optical device(s). This on-demand, switchable multiplexing scheme increases the intensity of light reaching the particular optical device(s) relative to a system in which each of the plurality of optical devices receives a constant, predetermined fraction of the light from the light source. This improves the SNR of the output (e.g., modulated) signal received by or from the detector, which in turn facilitates higher reliability and faster overall data rates of the improved optical communication and sensing system relative to conventional optical communication and sensing systems.

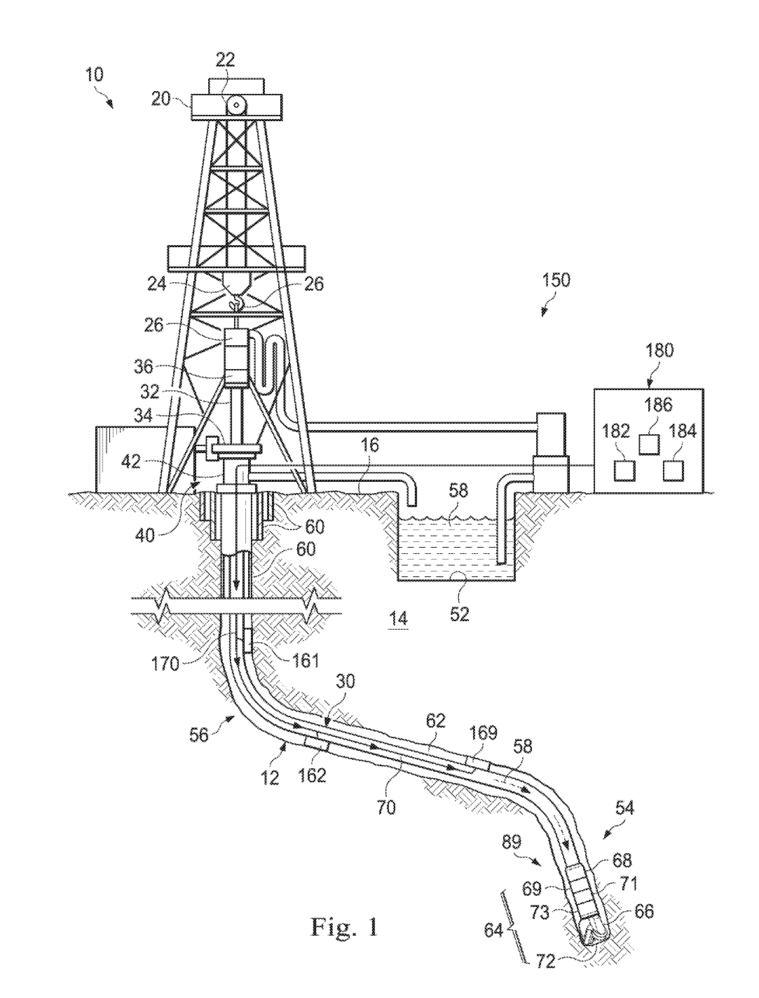

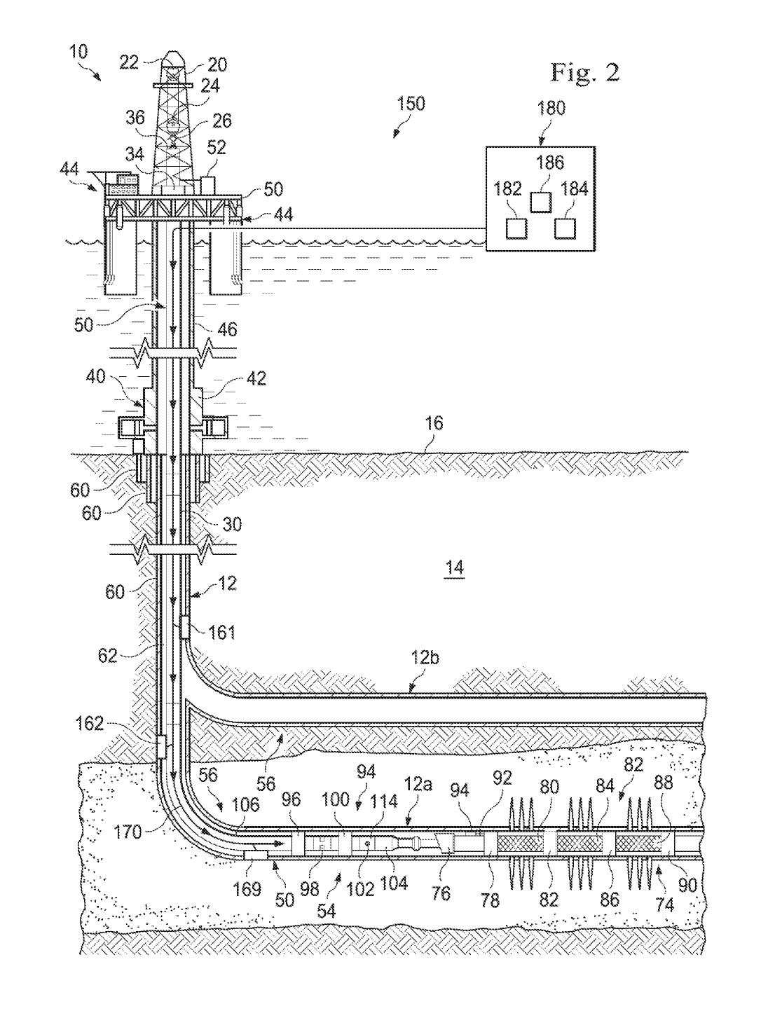

Turning to FIGS. 1 and 2, shown is an elevation view in partial cross-section of a wellbore drilling and production system 10 utilized to produce hydrocarbons from wellbore 12 extending through various earth strata in an oil and gas formation 14 located below the earth's surface 16. Wellbore 12 may be formed of a single or multiple bores 12a, 12b . . . 12n (illustrated in FIG. 2), extending into the formation 14, and disposed in any orientation, such as the horizontal wellbore 12b illustrated in FIG. 2.

Drilling and production system 10 includes a drilling rig or derrick 20. Drilling rig 20 may include a hoisting apparatus 22, a travel block 24, and a swivel 26 for raising and lowering casing, drill pipe, coiled tubing, production tubing, other types of pipe or tubing strings or other types of conveyance vehicles, such as wireline, slickline, and the like 30. In FIG. 1, conveyance vehicle 30 is a substantially tubular, axially extending drill string formed of a plurality of drill pipe joints coupled together end-to-end, while in FIG. 2, conveyance vehicle 30 is completion tubing supporting a completion assembly as described below. Drilling rig 20 may include a kelly 32, a rotary table 34, and other equipment associated with rotation and/or translation of tubing string 30 within a wellbore 12. For some applications, drilling rig 20 may also include a top drive unit 36.

Drilling rig 20 may be located proximate to a wellhead 40 as shown in FIG. 1, or spaced apart from wellhead 40, such as in the case of an offshore arrangement as shown in FIG. 2. One or more pressure control devices 42, such as blowout preventers (BOPs) and other equipment associated with drilling or producing a wellbore may also be provided at wellhead 40 or elsewhere in the system 10.

For offshore operations, as shown in FIG. 2, whether drilling or production, rig 20 may be mounted on an oil or gas platform 44, such as the offshore platform as illustrated, semi-submersibles, drill ships, and the like (not shown). Although system 10 of FIG. 2 is illustrated as being a marine-based production system, system 10 of FIG. 2 may be deployed on land.

Likewise, although system 10 of FIG. 1 is illustrated as being a land-based drilling system, system 10 of FIG. 1 may be deployed offshore. In any event, for marine-based systems, one or more subsea conduits or risers 46 extend from deck 50 of platform 44 to a subsea wellhead 40. Tubing string 30 extends down from drilling rig 20, through subsea conduit 46 and BOP 42 into wellbore 12.

A working or service fluid source 52 may supply a working fluid 58 pumped to the upper end of tubing string 30 and flow through tubing string 30. Working fluid source 52 may supply any fluid utilized in wellbore operations, including without limitation, drilling fluid, cementious slurry, acidizing fluid, liquid water, steam or some other type of fluid.

Wellbore 12 may include subsurface equipment 54 disposed therein, such as, for example, a drill bit and bottom hole assembly (BHA), a completion assembly or some other type of wellbore tool.

Wellbore drilling and production system 10 may generally be characterized as having a pipe system 56. For purposes of this disclosure, pipe system 56 may include casing, risers, tubing, drill strings, completion or production strings, subs, heads or any other pipes, tubes or equipment that attaches to the foregoing, such as string 30 and conduit 46, as well as the wellbore and laterals in which the pipes, casing and strings may be deployed. In this regard, pipe system 56 may include one or more casing strings 60 cemented in wellbore 12, such as the surface, intermediate and production casing 60 shown in FIG. 1. An annulus 62 is formed between the walls of sets of adjacent tubular components, such as concentric casing strings 60 or the exterior of tubing string 30 and the inside wall of wellbore 12 or casing string 60, as the case may be.

Where subsurface equipment 54 is used for drilling and conveyance vehicle 30 is a drill string, the lower end of drill string 30 may include bottom hole assembly (BHA) 64, which may carry at a distal end a drill bit 66. During drilling operations, weigh-on-bit (WOB) is applied as drill bit 66 is rotated, thereby enabling drill bit 66 to engage formation 14 and drill wellbore 12 along a predetermined path toward a target zone. In general, drill bit 66 may be rotated with drill string 30 from rig 20 with top drive 36 or rotary table 34, and/or with a downhole mud motor 68 within BHA 64. The working fluid 58 may be pumped to the upper end of drill string 30 and flow through the longitudinal interior 70 of drill string 30, through bottom hole assembly 64, and exit from nozzles formed in drill bit 66. At bottom end 72 of wellbore 12, drilling fluid 58 may mix with formation cuttings, formation fluids and other downhole fluids and debris. The drilling fluid mixture may then flow upwardly through an annulus 62 to return formation cuttings and other downhole debris to the surface 16.

Bottom hole assembly 64 and/or drill string 30 may include various other tools, including a power source 69, mechanical subs 71 such as directional drilling subs, and measurement equipment 73, such as measurement while drilling (MWD) and/or logging while drilling (LWD) instruments, sensors, circuits, or other equipment to provide information about wellbore 12 and/or formation 14, such as logging or measurement data from wellbore 12. Measurement data and other information from the tools may be communicated using electrical signals, acoustic signals or other telemetry that can be converted to electrical signals at the rig 20 to, among other things, monitor the performance of drilling string 30, bottom hole assembly 64, and associated drill bit 66, as well as monitor the conditions of the environment to which the bottom hole assembly 64 is subjected.

Also shown deployed in FIG. 1 and FIG. 2 is an optical communication and sensing system 150. Optical communication and sensing system 150 includes a plurality of optical devices 161-169 coupled to an optical transmission network 170 extending along drilling and production system 10 according to certain illustrative embodiments of the present disclosure.

Optical devices 161-169 may include sensors, modulators, or any other devices capable of receiving, transmitting, or otherwise detecting or embedding information in an electromagnetic signal. Optical devices 161-169 may be positioned along wellbore 12 at any desired location. In some embodiments, optical devices 161-169 may be positioned adjacent to or within bottom hole assembly 64. Alternately, or additionally, optical devices 161-169 may be permanently or removably attached to tubing string 30 and distributed throughout wellbore 12 in any area in which sample evaluation is desired. Optical devices 161-169 may be coupled to a remote power supply (located on the surface or a power generator positioned downhole along the wellbore, for example), while in other embodiments each of optical devices 161-169 comprises an on-board battery or other on-board power source (e.g., an energy harvesting device). In some embodiments, optical devices 161-169 may be passive devices that are not coupled to a power supply. Those ordinarily skilled in the art having the benefit of this disclosure will readily appreciate that the number and location of optical devices 161-169 may be selected as desired.

According to some embodiments, one or more of optical devices 161-169 may be optical sensors that optically interact with a sample of interest (wellbore fluid, downhole tool component, tubular component, or formation, for example) to determine a characteristic of a sample; optical devices 161-169 may also respond to electromagnetic fields emitted by, or having traversed a sample of interest. According to some embodiments, optical sensors may respond to temperature, strain, or acoustic properties of the surroundings, and then produce an optical signal that carries measured information associated with these properties. In certain illustrative embodiments, optical devices 161-169 may be dedicated to sample characteristic detection, as well as formation evaluation. Optical sensors may also determine the presence and quantity of specific inorganic gases such as, for example, CO2 and H2S, organic gases such as methane (C1), ethane (C2) and propane (C3) and saline water, in addition to dissolved ions (Ba, Cl, Na, Fe, or Sr, for example) or various other characteristics (pH, density and specific gravity, viscosity, total dissolved solids, sand content, etc.). Furthermore, the presence of formation characteristic data (porosity, formation chemical composition, etc.) may also be determined. In certain embodiments, a single optical sensor may detect a single characteristic, while in others a single optical sensor may determine multiple characteristics, as will be understood by those ordinarily skilled in the art having the benefit of this disclosure.

According to some embodiments, optical devices 161-169 may alternately, or additionally, detect other properties associated with a sample of interest including electromagnetic fields (e.g. microwave, radio frequency (RF), terahertz, and/or the like), strain, temperature, acoustic vibrations, and/or flow. Optical devices 161-169 may measure these properties by direct interaction with the sample of interest and/or may receive a signal from a transmitter. In some embodiments, a transmitter emits a signal into the formation, the signal is modified by the formation, and the modified signal is detected by the optical device. Accordingly, the modified signal carries information pertaining to one or more measured properties of the formation.

Optical devices 161-169 are communicatively coupled to a control module 180 via optical transmission network 170. Optical transmission network 170 may include one or more fiber-optic cables, waveguides, optical couplers (e.g., directional couplers), optical switches, optical circulators, optical drop multiplexers (ODMs), optical add multiplexers (OAMs), multiplexers (MUXs), demultiplexers (DMUXs), optical filters, optical mirrors, optical isolators, faraday rotator mirrors, and/or the like to deliver optical signals between or among optical devices 161-169 and control module 180. In some examples, an optical waveguide may include a single mode waveguide, multimode waveguide, photonic crystal waveguide (i.e., holey fiber), disordered fiber (e.g., polymer Anderson localized fiber), and/or the like. According to some embodiments a fiber-optic cable of optical transmission network 170 may extend between optical devices 161-169 and control module 180 via a slickline (e.g., when used to communicate logging information), a permanent cable cemented in wellbore 16, or a cable be aligned with a casing of pipe system 56. According to some embodiments, optical transmission network 170 may be disposed entirely within a measurement-while-drilling or logging-while-drilling tool.

According to some embodiments, optical transmission network 170 may deliver one or more optical signals between optical devices 161-169 and a source or destination other than control module 180, such as a downhole module, a remotely located module, a transceiver that converts the optical signals into another transmission format, or the like. Although optical devices 161-169 may each include an on-board light source used to generate optical signals for transmission over optical transmission network 170, in some embodiments, optical devices 161-169 may not have an on-board light source. In furtherance of such embodiments, optical devices 161-169 may receive light from an external source, embed information into the received light (e.g., using a modulator, encoder, or the like), and transmit the resulting optical signal over optical transmission network 170. According to some embodiments, optical devices 161-169 may include an inline fiber laser that receives pump light from an on-board or external light source over optical transmission network 170 and/or from an additional, independent transmission network.

Control module 180 includes a light source 182, detector 184, controller 186, and other circuitry as applicable to achieve the objectives of the present disclosure, as will be understood by those ordinarily skilled in the art having the benefit of this disclosure. In addition, it will also be recognized that any software instructions used to carry out the objectives of the present disclosure may be stored within storage located in control module 180 or loaded into that storage from a CD-ROM or other appropriate storage media via wired or wireless methods. Light source 182 may include any suitable source of electromagnetic radiation for use by optical devices 161-169, such as coherent, non-coherent, broadband, narrowband, pulsed, continuous, polarized, and/or unpolarized light sources. In some embodiments, light source 182 may be a laser or a light emitting diode (LED) with a fixed or tunable wavelength. It is to be understood that the objectives of the present disclosure may be achieved using light from any portion of the electromagnetic spectrum including, but not limited to, visible light, ultraviolet radiation, infrared radiation, and/or a combination thereof. In one or more embodiments, light source 182 may transmit modulated (information-bearing) or unmodulated light to optical devices 161-169;

unmodulated light from light source 182 can also become modulated externally via suitable optical and electronic components. When light source 182 generates modulated light, or the unmodulated light from light source 182 is externally modulated and then transmitted, the information embedded in the modulated light signal may include data or control signals for optical devices 161-169. In furtherance of such embodiments, optical devices 161-169 may include demodulators and decoders to extract, digitize, or otherwise process the information from the modulated light signal. Detector 184 may include any device suitable for converting a received optical signal into an electrical signal (or other signal format used by controller 186), such as a photodiode. Detector 184 may further include analog and/or digital signal processing circuitry, such as an amplifier. In some embodiments, detector 184 may output an analog or a digital signal representation of the received optical signal to controller 186.

In certain illustrative embodiments, control module 180, via controller 186, communicates with optical devices 161-169 to send and/or receive data or instructions during sensing, drilling, measurement-while-drilling, logging-while-drilling, production and/or other downhole operations. In some examples, optical devices 161-169 may each include a transmitter and receiver (transceiver, for example) that allows bi-directional communication over optical transmission network 170 in real-time. In some embodiments, however, optical devices 161-169 may be configured for one-way communication over optical transmission network 170. In furtherance of such embodiments, any suitable digital and/or analog encoding and/or modulation schemes may be employed to achieve reliable, secure, and/or high speed communication between optical devices 161-169 and control module 180. In one or more embodiments, the encoding and modulation scheme may include pulse width modulation, pulse position modulation, on-off keying, amplitude modulation, frequency modulation, phase modulation, polarization modulation, single-side-band modulation, frequency shift keying, phase shift keying (e.g., binary phase shift keying and/or M-ary phase shift keying), discrete multi-tone, orthogonal frequency division multiplexing, and/or the like. In certain illustrative embodiments, optical devices 161-169 that are configured as optical sensors may transmit all or a portion of the sample characteristic data to control module 180 for further analysis. However, in other embodiments, such analysis is completely handled by optical devices 161-169 and the resulting data is then transmitted to control module 180 for storage or subsequent analysis. In either embodiment, the processor handling the computations analyzes the characteristic data and, through utilization of Equation of State (“EOS”) or other optical analysis techniques, derives the sample characteristic indicated by the transmitted data, as will be readily understood by those ordinarily skilled in the art having the benefit of this disclosure.

Still referring to the illustrative embodiment of FIG. 1, optical devices 161-169 are positioned along wellbore 12 at any desired location. In some embodiments, optical devices 161-169 may have a temperature and pressure resistant housing sufficient to withstand the harsh downhole environment. A variety of materials may be utilized for the housing, including, for example, stainless steels and their alloys, titanium and other high strength metals, and even carbon fiber composites and sapphire or diamond structures, as understood in the art. In certain embodiments, optical devices 161-169 are dome-shaped modules (akin to a vehicle dome light) which may be permanently or removably attached to a surface using a suitable method (welding, magnets, etc.). Module housing shapes may vary widely, provided they isolate components from the harsh down-hole environment while still allowing a unidirectional or bidirectional optical (or electromagnetic radiation) pathway from sensor to the sample of interest. As will be understood by those ordinarily skilled in the art having the benefit of this disclosure, dimensions would be determined by the specific application and environmental conditions.

Alternatively, or additionally, optical devices 161-169 may form part of tubing string 30 along its inner diameter (to detect the presence of fluids flowing through longitudinal interior 70 of tubing string 30, for example) or outer diameter (to detect presence of fluids flowing through the annulus between tubing string 30 and pipe system 56 or formation characteristic data, for example). In other embodiments, optical devices 161-169 may be coupled to tubing string 30 using an extendable arm (adjustable stabilizer, casing scraper, downhole tractor, for example) in order to extend optical devices 161-169 into close proximity with another surface (casing, tool body, formation, etc.) to thereby detect sample characteristics. In some embodiments, optical devices 161-169 may also be permanently affixed to the inner diameter of pipe system 56 by a welding or other suitable process. However, in yet another embodiment, optical devices 161-169 are removably affixed to the inner diameter of pipe system 56 using magnets or physical structures so that optical devices 161-169 may be periodically removed for service purposes or otherwise.

Although optical signals are ideally transmitted and received over optical transmission network 170 without noise, in practice the communication channel is noisy. Sources of noise may include light source 182, components of optical transmission network 170 (e.g., the fiber-optic cables, optical switches, connectors, or the like), detector 184, or associated electronic circuits. Accordingly, it is desirable for the signal strength (i.e., the intensity of the light transmitted through optical transmission network 170) to be sufficiently large to allow fast and reliable communications over the noisy communication channel. That is, the signal-to-noise ratio (SNR) should be as large as possible to achieve high-bandwidth, accurate signal transmission.

One challenge to achieving a high SNR is the fact that, in some embodiments of optical communication and sensing system 150, the number of optical devices 161-169 outnumbers the number of light sources 182 and/or detectors 184. For example, optical communication and sensing system 150 may include two or more optical devices 161-169, a single light source 182, and a single detector 184. In fact, some embodiments of optical communication and sensing system 150 may include over 100 optical devices 161-169. Multiplexing techniques implemented by optical transmission network 170 allow the plurality of optical devices 161-169 to share access to light source 182 and detector 184. The choice of multiplexing techniques may have a significant impact on the SNR of optical communication and sensing system 150. A multiplexing technique with a fixed configuration generally distributes light from light source 182 to all of optical devices 161-169 in a constant manner. Thus, the light reaching each of optical devices 161-169 is attenuated in proportion to the total number of optical devices 161-169. For example, in a system with 100 optical devices 161-169, each optical device receives approximately 1/100 of the light from light source 182 (the actual amount of light received may be even lower due to losses with optical transmission network 170). Such a multiplexing scheme is difficult to scale to systems with a large number of optical devices 161-169, because the amount of light reaching each of optical devices 161-169 (i.e., the signal strength) is too low to achieve an SNR that allows for optical signals to be communicated with a high information rate and accuracy.

Accordingly, improved multiplexing techniques that increases the amount of light reaching each of optical devices 161-169 during communication is desired.

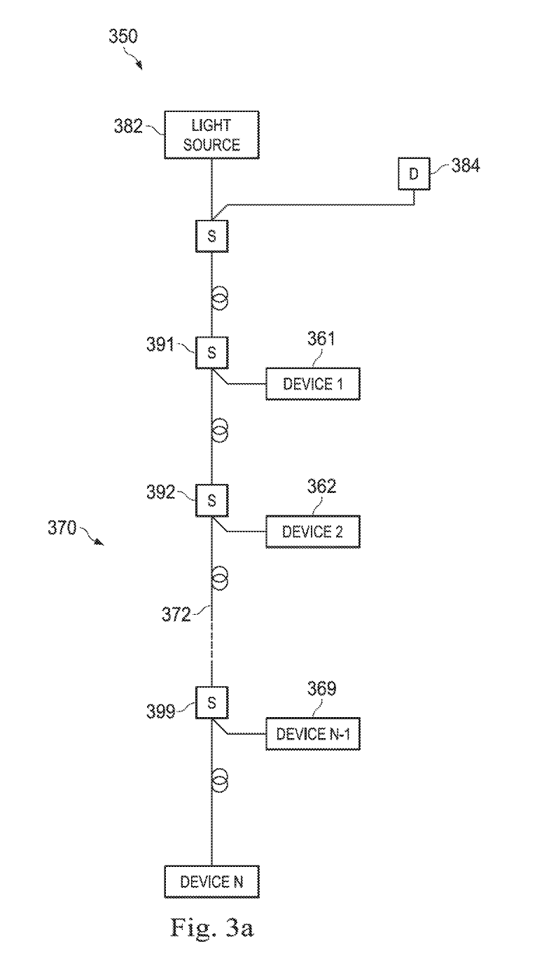

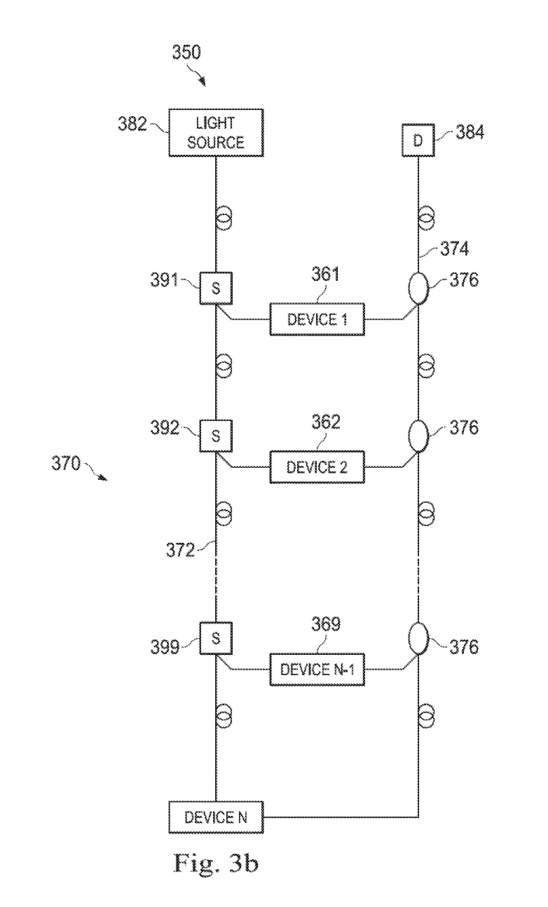

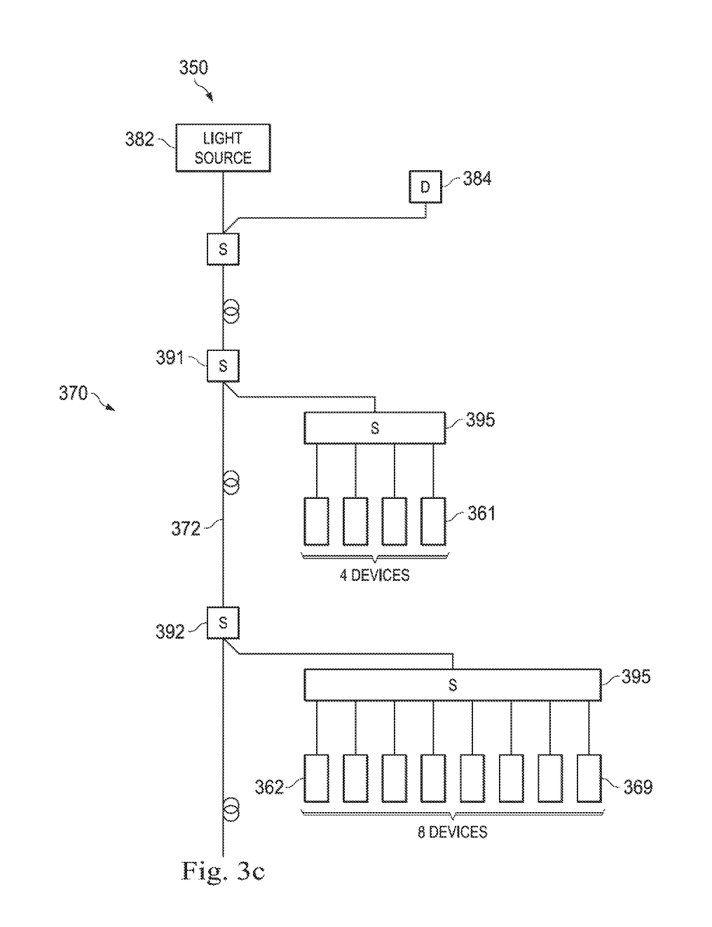

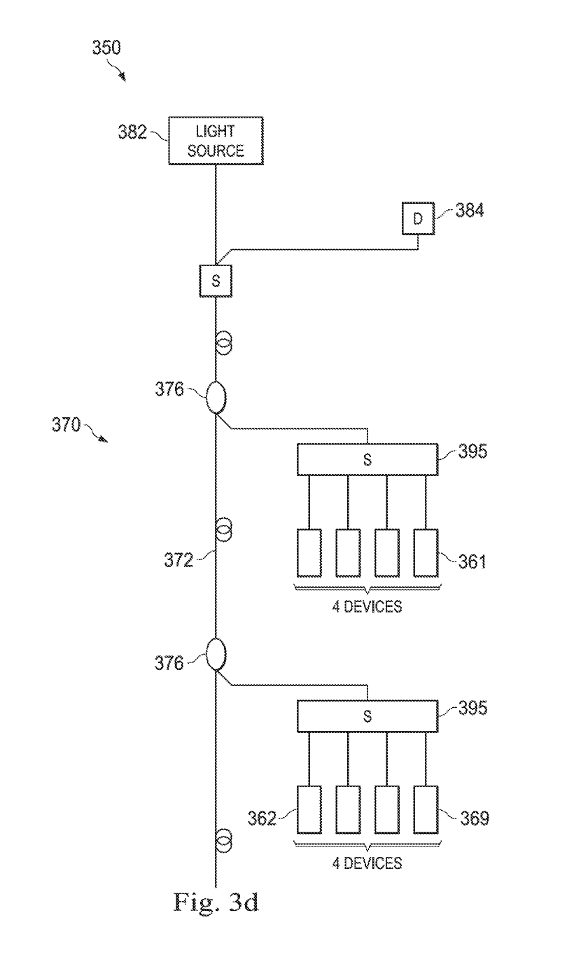

FIGS. 3a-d illustrate embodiments of an optical communication and sensing system 350 using optical switches according to some embodiments. According to some examples consistent with FIGS. 1 and 2, optical communication and sensing system 350 may be used to implement optical system 150. Like optical communication and sensing system 150, optical communication and sensing system 350 includes an optical transmission network 370 that distributes modulated or unmodulated light from light source 382 among a plurality of optical devices 361-369 and/or delivers optical signals from optical devices 361-369 to detector 384. Optical transmission network 370 uses a dynamic multiplexing scheme that switchably distributes light among optical devices 361-369. That is, the dynamic multiplexing scheme routes light from light source 382 to a selected group of one or more of optical devices 361-369. The selected group is a subset of all optical devices 361-369 coupled to optical transmission network 370. The selected group may be dynamically changed in real-time to correspond to the group of optical devices 361-369 with which communication is desired at a given time. Optical devices 361-369 which are not part of the select group at a given time do not receive light (or receive only a trace amount of leakage light) from light source 382 or transmit optical signals to detector 384.

One advantage of using a dynamic multiplexing scheme that switchably distributes light from light source 382 among a selected group of optical devices 361-369 is that a large portion of light produced by light source 382 reaches each optical device in the selected group. For example, when the selected group includes a single optical device selected from optical devices 361-369, all of the light from light source 382 is delivered to the selected optical device (neglecting optical losses in optical transmission network 370). Thus, the SNR of the optical signal received from the selected optical device, which is proportional to the amount of light that reaches the optical device, may be large. This is in contrast to the fixed multiplexing scheme described above, in which all of optical devices 361-369 receive a constant fraction of the light produced by light source 382. For example, in a system with 100 optical devices, a dynamic multiplexing scheme may deliver up to 100 times greater light intensity to a selected optical device than a fixed multiplexing scheme that divides the light evenly among the 100 optical devices. Accordingly, the SNR of the optical signal transmitted using the dynamic multiplexing scheme is approximately 100 times greater than the optical signals transmitted using the fixed multiplexing scheme (assuming for the sake of simplicity that the noise of the communication channel is independent of the light intensity).

According to some embodiments, in order to implement a dynamic multiplexing scheme, optical transmission network 370 may include one or more optical switches 391-399. In general, each of optical switches 391-399 has one or more inputs to receive light, two or more outputs to transmit the received light, and one or more control inputs to receive control signals. According to some embodiments, optical switches 391-399 may include interferometric (e.g. Mach-Zehnder interferometer), mechanical (e.g. microelectromechanical (MEMS) or micro-optoelectromechanical (MOEMS)), electro-optic, acousto-optic, or thermal optical switches. In some examples, the input of optical switches 391-399 may be connected to a fiber optic cable 372 coupled to light source 382, and each output may be connected to fiber optic cables, each output cable being coupled to different optical devices 361-369. In response to the control signal, each optical switch distributes the received light among its two or more outputs. For example, when an optical switch has one input and a first and second output, the optical switch may selectively transmit received light to the first output when the control signal has a first value and the second output when the control signal has a second value. According to some embodiments, the control signal received by each optical switch may include a data signal, a voltage level, an optical signal, an acoustic signal, a thermal signal, or the like. Although the control signal may be received from an external source, such as a controller of a control module, it is to be understood that the control signal may alternately, or additionally, be received from an on-board mechanism, such as an on-board timer that periodically toggles among the various switching states of the optical switch. Moreover, the control signal may be received from or otherwise associated with the downhole environment and may be generated, for example, using energy harvesting techniques.

Although portions of optical transmission network 370 depicted in FIGS. 3a-d may be located above or adjacent to the surface, much of optical transmission network 370, including at least one of optical switches 391-399, may be disposed within a wellbore. One advantage of disposing one or more of optical switches 391-399 within the wellbore is that the number of fiber optic cables in the wellbore is reduced. For example, the number of fiber optic cables running in parallel in a typical wellbore may be limited to approximately five due to physical constraints.

Utilizing the techniques described herein, this limit of five fiber optic cables may be easily accommodated by multiplexing signals from a plurality of optical devices 361-369 onto a single fiber optic cable (or at least less than five fiber optic cables) using optical switches 391-399 located at appropriate positions within the wellbore.

An optical transmission network 370 that includes one or more optical switches 391-399 may be configured in a variety of topologies. Four illustrative topologies are discussed below, although one of ordinary skill would recognize that similar functionality may be achieved using numerous topologies in addition to the four discussed below. Moreover, while the illustrative topologies are depicted as including components such as optical couplers and optical switches, it is to be understood that optical transmission network 370 may additionally or alternately include a wide variety of suitable optical elements, including but not limited to optical circulators, optical drop multiplexers (ODMs), optical add multiplexers (OAMs), multiplexers (MUXs), demultiplexers (DMUXs), optical filters, optical mirrors, optical isolators, and/or the like. The four illustrative topologies discussed below are: (1) bidirectional switched-bus topology, (2) unidirectional hybrid-bus topology, (3) switched tree topology, and (4) hybrid tree topology.

Referring to the illustrative embodiment of FIG. 3a, optical transmission network 370 is arranged in a bidirectional switched-bus topology. In this topology, fiber optic cable 372 is configured as a bus running substantially the entire length of optical communication and sensing system 350. Light source 382 and detector 384 are disposed at an “upstream” end of the bus. Each of optical devices 361-369 is coupled to the bus through a corresponding one of optical switches 391-399. Each of optical switches 391-399 receives light from light source 382 via an upstream portion of the bus and outputs the light to either a downstream portion of the bus or to a corresponding one of optical devices 361-369. Similarly, each of optical switches 391-399 receives an optical signal from either a downstream portion of the bus or from its corresponding optical device and transmits the received optical signal to an upstream portion of the bus towards detector 384. In this configuration, the bus is bidirectional; that is, light is routed both (1) downstream from light source 382 towards optical devices 361-369 and (2) upstream from optical devices 361-369 towards detector 384. When optical communication with a particular optical device among optical devices 361-369 is desired, a control signal is transmitted to the corresponding optical switch to route light from light source 382 towards the particular optical device. Otherwise, when optical communication with the particular optical device is not desired, the control signal is set such that the corresponding optical switch routes light from light source 382 towards a downstream portion of the bus rather than towards the particular optical device. In the latter case, none of the light from light source 382 reaches the particular optical device, and thus the light remains available for achieving high-SNR communication with other optical devices positioned downstream relative to the particular optical device.

Referring to the illustrative embodiment of FIG. 3b, optical transmission network 370 is arranged in a unidirectional hybrid-bus topology. In this topology, as in the bidirectional switched-bus topology depicted in FIG. 3a, fiber optic cable 372 is configured as a switched bus (i.e., each of optical devices 361-369 is associated with a different one of optical switches 391-399 positioned along the bus). However, instead of routing the return optical signals towards detector 384 along the same switched bus, the optical signals from optical devices 361-399 are routed towards detector 384 along a second bus corresponding to fiber optic cable 374. Optical signals from each of optical devices 361-369 are merged onto fiber optic cable 374 using couplers 376. Couplers 376 may include directional couplers and/or star couplers and are generally passive devices (i.e., they perform a fixed, rather than switchable, function) that receive optical signals from two or more downstream inputs and transmit the merged optical signal towards detector 384 on an upstream output. This topology is referred to as a hybrid bus topology because it includes both a switched bus (fiber optic cable 372) and a non-switched bus (fiber optic cable 374).

Referring to the illustrative embodiment of FIG. 3c, optical transmission network 370 is arranged in a bidirectional switched tree topology. In this topology, as in the bidirectional switched-bus topology depicted in FIG. 3a, fiber optic cable 372 is configured as a bus (or “trunk”) along which optical switches 361-369 are disposed. However, unlike the bidirectional switched bus topology, in which each optical device is directly coupled to the bus through a corresponding optical switch, the bidirectional switched tree topology includes one or more additional layers of optical switches 395 (“branches”) situated between each optical device and the trunk. Optical switches 395 distribute light from the trunk among the particular optical devices associated with each branch. As depicted in FIG. 3c, optical switches 395 may switchably distribute a single upstream input among two, or more than two, downstream outputs. The switched tree topology depicted in FIG. 3c is bidirectional, meaning that light is transmitted from light source 382 to optical devices 361-369 and optical signals are returned from optical devices 361-369 to detector 384 along the same optical path. One advantage of the bidirectional switched tree topology relative to the bidirectional switched bus topology is that the average number of optical switches between a particular optical device and light source 382 or detector 384 is reduced. To the extent that optical switches are often associated with losses or other non-idealities that decrease the optical signal strength and/or increase the noise of the communication channel, the bidirectional switched tree topology may thus offer improved SNR relative to other topologies.

Referring to the illustrative embodiment of FIG. 3d, optical transmission network 370 is arranged in a bidirectional hybrid tree topology. This topology is similar to the bidirectional switched tree topology as depicted in FIG. 3c. However, one or more of optical switches 391-399 are substituted with couplers 376. As discussed previously with respect to FIG. 3b, couplers 376 are passive devices and are not switchable. Rather than switchably routing light from light source 382 among a plurality of optical devices 361-369, couplers 376 split the light received from light source 384 among the outputs in a constant manner. Thus, each directional coupler disposed between a light source 382 and a particular optical device reduces the maximum amount of light from light source 382 that can reach the particular optical device. The reduction in light intensity is proportional to the percentage of light allocated to the particular branch of each directional coupler on which the particular optical device is located. Although the amount of light reaching particular optical devices is reduced in this topology, the light intensity may still be sufficiently high for the desired communications to take place. Moreover, because couplers 376 are not associated with control signals, the hybrid topology may be simpler to operate than a fully switched topology.

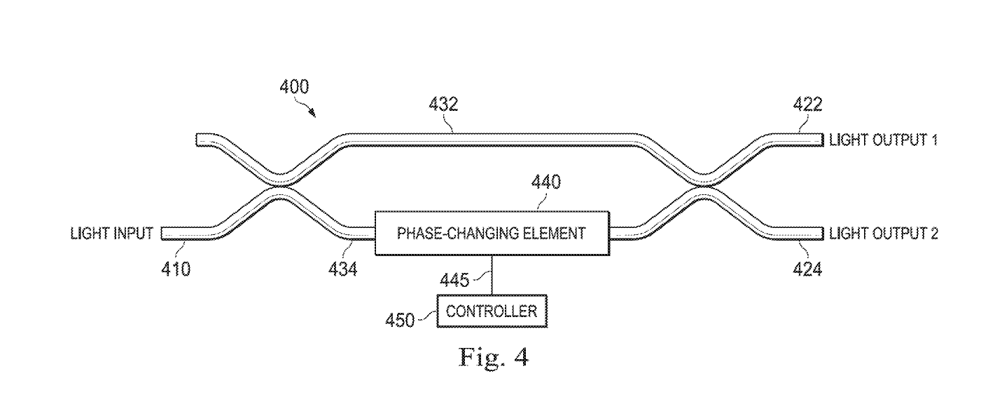

FIG. 4 is an illustration of an optical switch 400 according to some embodiments. As depicted in FIG. 4, optical switch 400 is configured as a Mach-Zehnder interferometer optical switch. In some embodiments consistent with FIGS. 1-3, one or more of optical switches 391-399 of optical transmission network 370 may be instances of optical switch 400. Optical switch 400 includes a light input 410 and two light outputs 422 and 424. Furthermore, optical switch 400 includes two optical paths 432 and 434. One of the optical paths (optical path 434) includes a phase-changing element 440. Phase-changing element 440 receives a control signal 445 from a controller 450. According to some embodiments consistent with FIGS. 1-3, controller 450 may be an external controller, such as controller 186 located within control module 180. Alternately, or additionally, controller 450 may include an on-board controller located within or in close proximity to optical switch 400. A phase difference between optical path 432 and optical path 434 determines the fraction of light from light input 410 that exits through each of light outputs 422 and 424. Thus, optical switch 400 may be switchably operated by controlling the phase of path 434. This is accomplished by applying control signal 445 to phase-changing element 440. For example, when optical switch 400 is a voltage-controlled optical switch, control signal 445 may be generated electronically and transmitted as an applied voltage.

Although a voltage-controlled Mach-Zehnder interferometer optical switch is depicted for illustrative purposes, it is to be understood that optical switch 400 may be adapted to employ any number of suitable optical switching techniques, including but not limited to other interferometric techniques, mechanical (e.g. microelectromechanical (MEMS) and microoptoelectromechanical (MOEMS)) techniques, electro-optic techniques, acousto-optic techniques, or thermal techniques. Moreover, in addition (or as an alternative) to an electronic signal, control signal 445 may include an optical control signal communicated from controller 450 to optical switch 400 over optical transmission network 370. In furtherance of such embodiments, the received optical control signal 445 may interact thermally with phase-changing element 440 (e.g., by heating up phase-changing element 440) to switch the state of optical switch 400. One advantage of transmitting control signal 445 optically over optical transmission network 370 is a reduction in the total number of components of optical communication and sensing system 350. That is, optical transmission network 370 serves the dual purpose of conveying information associated optical devices 361-360 and transmitting control signals associated with optical switches 391-399.

As discussed above and further emphasized here, FIGS. 1-4 are merely examples which should not unduly limit the scope of the claims. One of ordinary skill in the art would recognize many variations, alternatives, and modifications. According to one or more embodiments, optical switches 391-399 may be frequency or wavelength dependent optical switches so as to route light differently depending on its wavelength. In some embodiments, optical communication system 150 may be used for one-way communication from optical devices 161-169 to controller: optical devices 161-169 receive unmodulated light from light source 182 and return a modulated (information-bearing) optical signal to detector 184. In some embodiments, optical communication and sensing system 150 may be used for two-way communication between optical devices 161-169 and controller 186: light is modulated in both the upstream and the downstream direction.

FIG. 5 illustrates a control module 580 according to some embodiments. According to some examples consistent with FIGS. 1-2, control module 580 may be used to implement control module 180. As in control module 180, control module 580 includes a light source 582, detector 584, and controller 586. In one or more embodiments, control module 580 may be configured to transmit a modulated light signal over an optical transmission network, such as optical transmission network 170. In furtherance of such embodiments, controller 586 may include an encoder 592 and one or more of an electrical modulator 594a, and an optical modulator 594b. In one or more embodiments, encoder 592 may receive as an input analog and/or digital data to be transmitted over optical transmission network 170 and convert the received data into a stream of bits. In one or more embodiments, encoder 592 may perform various operations on the incoming data including source encoding, interleaving, encryption, channel encoding, convolutional encoding, and/or the like. In one or more embodiments, modulators 594a and/or 594b may convert the stream of data generated by encoder 592 into a modulated light signal according to a variety of modulation schemes including pulse width modulation, pulse position modulation, on-off keying, amplitude modulation, frequency modulation, phase modulation, polarization modulation, single-side-band modulation, frequency shift keying, phase shift keying (e.g., binary phase shift keying and/or M-ary phase shift keying), discrete multi-tone, orthogonal frequency division multiplexing, and/or the like. In some embodiments, electrical modulator 592a may generate an analog or digital electrical signal that is sent to light source 582 to cause light source 182 to output a modulated light signal. Alternately or additionally, optical modulator 592b may receive light output from light source 582 and embed information into the light signal. For example, optical modulator 592b may include an acousto-optic modulator, electro-optic modulator, semiconductor optical amplifier, MEMS/MOEMS switch, Kerr cell, and/or the like for modulating a continuous light output from light source 582.

In one or more embodiments, control module 580 may be additionally and/or alternately configured as an encoded signal receiver of an optical communication and sensing system. In furtherance of such embodiments, controller 586 may include a decoder 593 and one or more of an electrical demodulator 595a or an optical demodulator 595b. The functions performed by decoder 593 and demodulators 595a-b generally mirror the functions performed by encoder 592 and modulators 594a-b. Thus, for example, decoder 593 may perform source decoding, de-interleaving, channel decoding, convolutional decoding, and/or the like. According to some embodiments, optical demodulator 595b may include a 3-by-3 optical coupler and/or an associated delay path configured to perform homodyne interrogation and demodulation.

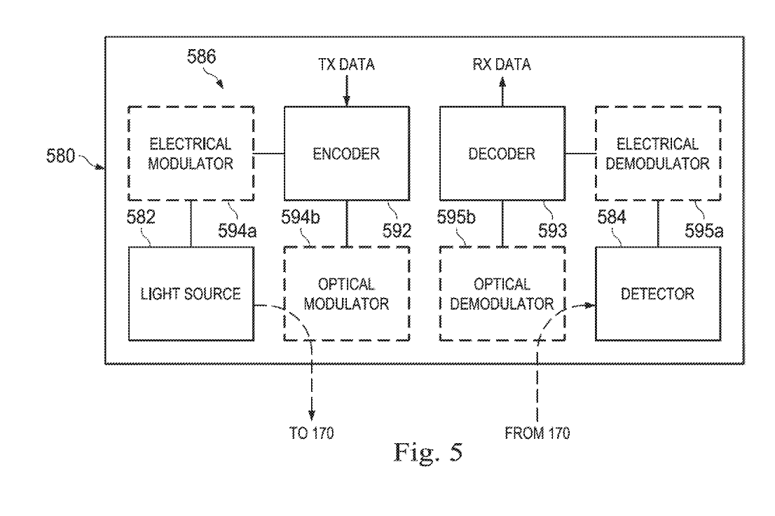

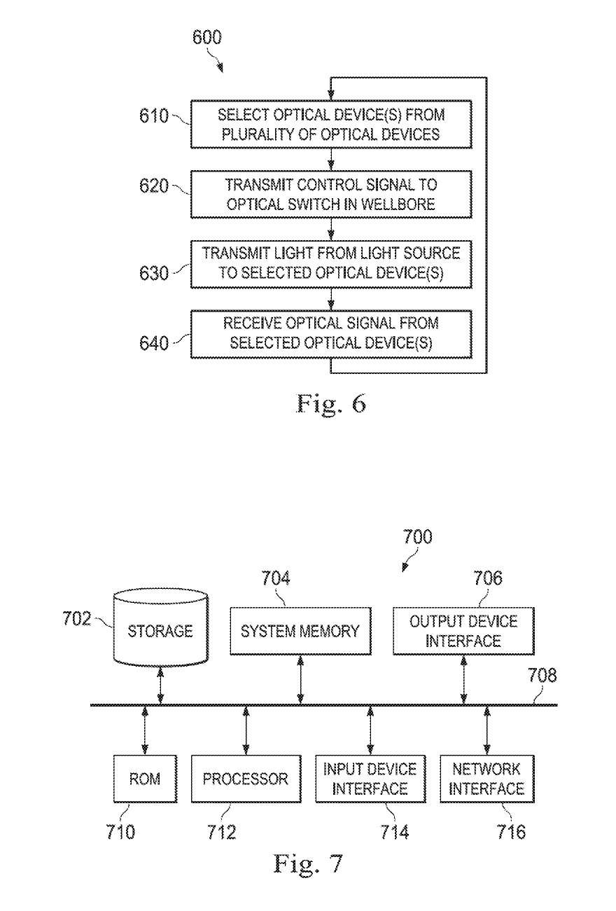

FIG. 6 illustrates a method 600 for performing optical multiplexing using optical switching according to some embodiments. According to some embodiments consistent with FIGS. 1-5, method 600 may be performed by a controller of an optical communication system, such as controller 184 of optical communication and sensing system 150, during communication between the controller and a plurality of optical devices disposed in a wellbore, such as optical devices 161-169.

At a process 610, an optical device or a group of optical devices is selected from among the plurality of optical devices. The selected optical device(s) are those with which the controller desires to communicate at a given time. For example, an optical device may be selected when the controller would like to send instructions to the optical device or receive data from the optical device.

At a process 620, a control signal is transmitted to an optical switch disposed in a wellbore. According to some embodiments consistent with FIGS. 1-4, the control signal may correspond to control signal 445 and the optical switch may correspond to optical switch 400. The control signal may include a voltage signal, an optical signal, a data signal, and/or the like. The value of the control signal is determined based on the selected optical device(s). The value of the control signal is also determined based on the topology of the optical communication system, including the location of a light source, such as light source 182, and a detector, such as detector 184, in relation to the optical devices. Once the value of the control signal is determined, the control signal is transmitted to the optical switch. The control signal directs the optical switch to route light from the light source towards the selected optical device or group of optical devices. This is accomplished by changing the state of the optical switch based on the value of the control signal. According to some embodiments, when there are a plurality of optical switches in the optical communication system that are situated between the light source and the selected optical device(s), a plurality of control signals may be transmitted such that each of the optical switches routes the light to the selected optical device(s). For example, when the topology is a bidirectional switched tree topology, one or more control signals may be transmitted to one or more corresponding optical switches situated along a fiber optic cable configured as a trunk of the tree topology, and one or more control signals may be transmitted to one or more corresponding secondary optical switches situated along a branch of the tree topology.

At a process 630, light is transmitted from the light source to the selected optical device(s). The light from the light source may be modulated (information-bearing) or unmodulated. Because the optical switches are directed to route the light from the light source to the selected optical device(s) during process 620, substantially all of the light from the light source reaches the selected optical device(s). That is, none of the light (or a very small portion of the light, in the case of non-ideal optical switches) is distributed to the optical devices that are not selected. According to some embodiments, such as those employing the hybrid tree topology discussed in FIG. 3d, some of the light may be distributed by directional couplers towards optical devices that are not selected. However, the amount of light that is directed towards optical devices that are not selected may be set during the design of the topology so as to ensure that sufficient light reaches the selected optical devices for the intended purpose.

At a process 640, one or more optical signals from the selected optical device(s) are received by the detector. The received optical signal includes embedded information from the optical device(s) that received the transmitted light during process 630. For example, according to some embodiments, the optical device(s) receive the transmitted light, modulate the received light to include data or other information (e.g., sample information associated with the wellbore or surrounding fluids measured by the optical device), and transmit the resulting optical signal back to the detector either along the same path from which the light was received (i.e., a bidirectional topology as illustrated in FIGS. 3a, 3c, and 3d) or a different path (i.e., a unidirectional topology as illustrated in FIG. 3b). According to some examples, the detector may convert the received optical signal into an analog or digital electronic signal representation and send the electronic signal representation to the controller for further processing. When more than one optical device is selected at a given time, the detector and/or the controller may demultiplex the received optical signal using any of a variety of techniques such as time division multiplexing, frequency division multiplexing, wavelength division multiplexing, hybrid wavelength and time division multiplexing, spatial division multiplexing, code division multiplexing and other spread spectrum techniques, optical frequency-domain multiplexing, coherence division multiplexing and/or the like.

Because most of the light from light source reaches the selected optical device(s) when performing method 600, the signal strength of the optical signal reaching the detector is very high. For example, when the total number of optical devices is 100 and a single optical device is selected, the optical signal from the selected optical device may be up to 100 times stronger than conventional methods in which the signal strength is divided evenly among all optical devices. Assuming the noise level is approximately independent of the optical signal strength, the SNR is also up to 100 times greater. This allows for far more accurate and/or higher bandwidth communication with the selected optical device. After process 640, method 600 may return to processes 610 to select a different set of one or more optical devices to communicate with.

Because the optical communication system is switchable, the light from the light source may be rerouted using the optical switches to provide similarly strong optical signals and SNR for the different optical device.

FIG. 7 is a block diagram of an exemplary computer system 700 in which embodiments of the present disclosure may be implemented adapted for performing optical multiplexing using optical switches. For example, the steps of the operations of method 500 of FIG. 5 and/or the components of controller 186 or controller 450 of FIGS. 1, 2, and 4, as described above, may be implemented using system 700. System 700 can be a computer, phone, personal digital assistant (PDA), or any other type of electronic device. Such an electronic device includes various types of computer readable media and interfaces for various other types of computer readable media. As shown in FIG. 7, system 700 includes a permanent storage device 702, a system memory 704, an output device interface 706, a system communications bus 708, a read-only memory (ROM) 710, processing unit(s) 712, an input device interface 714, and a network interface 716.

Bus 708 collectively represents all system, peripheral, and chipset buses that communicatively connect the numerous internal devices of system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of system 700. Permanent storage device 702, on the other hand, is a read-and-write memory device. This device is a non-volatile memory unit that stores instructions and data even when system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702 Like permanent storage device 702, system memory 704 is a read-and-write memory device. However, unlike storage device 702, system memory 704 is a volatile read-and-write memory, such a random access memory. System memory 704 stores some of the instructions and data that the processor needs at runtime. In some implementations, the processes of the subject disclosure are stored in system memory 704, permanent storage device 702, and/or ROM 710. For example, the various memory units include instructions for computer aided pipe string design based on existing string designs in accordance with some implementations. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to system 700. Input devices used with input device interface 814 include, for example, alphanumeric, QWERTY, or T9 keyboards, microphones, and pointing devices (also called “cursor control devices”). Output device interfaces 706 enables, for example, the display of images generated by system 700. Output devices used with output device interface 706 include, for example, printers and display devices, such as cathode ray tubes (CRT) or liquid crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG. 7, bus 708 also couples system 700 to a public or private network (not shown) or combination of networks through a network interface 716. Such a network may include, for example, a local area network (LAN), such as an Intranet, or a wide area network (WAN), such as the Internet. Any or all components of system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself. Accordingly, the steps of the operations of method 600 of FIG. 6, as described above, may be implemented using system 700 or any computer system having processing circuitry or a computer program product including instructions stored therein, which, when executed by at least one processor, causes the processor to perform functions relating to these methods.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

Thus, an optical communication and sensing system with optical switches has been described. Embodiments of an optical communication and sensing system with optical switches include a plurality of downhole optical devices communicatively coupled to an optical transmission network, and at least one optical switch disposed within the optical transmission network, the at least one optical switch switchably distributing light among the plurality of downhole optical devices. Likewise, an optical communication system for use in a wellbore extending from a surface has been described and may generally include, a plurality of downhole optical devices positioned in the wellbore and communicatively coupled to an optical transmission network, and at least one optical switch disposed within the optical transmission network, the at least one optical switch switchably distributing light among the plurality of downhole optical devices.

For any of the foregoing embodiments the system may include any one of the following elements, alone or in combination with each other: the plurality of downhole optical devices comprise one or more downhole optical sensors; the one or more downhole optical sensors optically interact with a sample of interest to determine a sample characteristic, the sample of interest comprising at least one of wellbore fluid, a downhole tool component, a tubular, and a formation; the sample characteristic is selected from a group comprising the presence, quantity, or attribute of: inorganic gases, organic gases, saline water, dissolved ions, pH, density and specific gravity, viscosity, total dissolved solids, sand content, porosity, and formation chemical composition; the inorganic gases comprise one or more of CO2 and H2S; the organic gases comprise one or more of methane (C1), ethane (C2) and propane (C3); and the dissolved ions comprise one or more of Ba, Cl, Na, Fe, and Sr; the sample characteristic is selected from a group comprising electromagnetic fields, strain, temperature, acoustic vibration, and flow; the optical transmission network is arranged in a bidirectional switched bus topology; the optical transmission network is arranged in a unidirectional hybrid bus topology; the optical transmission network is arranged in a bidirectional switched tree topology; the optical transmission network is arranged in a bidirectional hybrid tree topology; the plurality of downhole optical devices each comprise an on-board light source; the on-board light source comprises an inline fiber laser; a wavelength of light output by the inline fiber laser shifts as a function of strain associated with the inline fiber laser; the system further comprises a light source and a detector communicatively coupled to the plurality of downhole optical devices; the plurality of downhole optical devices are configured to receive light from the light source, modulate the light to form an optical signal with information embedded therein, and transmit the optical signal to the detector; the system further comprises a controller communicatively coupled to the detector, wherein the detector transmits an electronic representation of the optical signal to the controller; the light source, the detector, and the controller are disposed in a control module; the controller is configured to: select one or more particular downhole optical devices among the plurality of downhole optical devices, transmit a control signal to a particular optical switch among the at least one optical switch, the control signal directing the particular optical switch to route light from the light source towards the particular optical device, and receive an electronic representation of the optical signal transmitted by the particular optical device; substantially all of the light from the light source reaches the particular optical device; the control signal comprises at least one of a data signal, a voltage signal, an optical signal, an acoustic signal, and a thermal signal; the control signal is an optical signal transmitted to the particular optical switch over the optical transmission network; and the at least one optical switch is disposed within the wellbore.

A method for communicating with a plurality of downhole optical devices over an optical transmission network comprising at least one optical switch has been described. Embodiments of the method may include selecting one or more particular downhole optical devices among the plurality of downhole optical devices, transmitting a control signal to a particular optical switch among the at least one optical switch, the control signal directing the particular optical switch to route light from the light source towards the particular optical devices, and receiving an electronic representation of an optical signal transmitted by the particular optical devices.

For the foregoing embodiments, the method may include any one of the following steps, alone or in combination with each other: the optical signal has a signal strength that is proportional to an amount of light from the light source that reaches the particular optical devices; and multiplexing/demultiplexing the optical signal transmitted by the particular device using at least one of frequency division, time division, wavelength division, hybrid (e.g., wavelength and time division), spatial division, spread spectrum (e.g., code division multiplexing), optical frequency-domain, and coherence division multiplexing techniques; the hybrid technique is selected from one or more of a group comprising: wavelength division and time division, time division and spread-spectrum, time division with frequency division, time division and optical frequency-domain, spatial division and time division, space division and wavelength division, space division and spread-spectrum, space division and frequency division, and space division and optical frequency-domain; the optical signal is modulated using one or more of a group comprising amplitude modulation, frequency/phase modulation, and polarization modulation.

While the foregoing disclosure is directed to the specific embodiments of the disclosure, various modifications will be apparent to those skilled in the art. It is intended that all variations within the scope and spirit of the appended claims be embraced by the foregoing disclosure.

1. An optical communication and sensing system, the optical communication and sensing system comprising:
a plurality of downhole optical devices communicatively coupled to an optical transmission network; and
at least one optical switch disposed within the optical transmission network, the at least one optical switch switchably distributing light among the plurality of downhole optical devices.

2. An optical communication and sensing system for use in a wellbore extending from a surface, the optical communication and sensing system comprising:
a plurality of downhole optical devices positioned in the wellbore and communicatively coupled to an optical transmission network; and
at least one optical switch disposed within the optical transmission network, the at least one optical switch switchably distributing light among the plurality of downhole optical devices.

3. The system of claim 1, wherein the plurality of downhole optical devices comprise one or more downhole optical sensors.

4. The system of claim 3, wherein the one or more downhole optical sensors determine a sample characteristic of a sample of interest, the sample of interest comprising at least one of wellbore fluid, a downhole tool component, a tubular, and a formation.

5. The system of claim 4, wherein the sample characteristic is selected from a group comprising the presence, quantity, or attribute of: inorganic gases, organic gases, saline water, dissolved ions, pH, density and specific gravity, viscosity, total dissolved solids, sand content, porosity, and formation chemical composition.

6. The system of claim 5, wherein the inorganic gases comprise one or more of CO2 and H2S; the organic gases comprise one or more of methane (C1), ethane (C2) and propane (C3); and the dissolved ions comprise one or more of Ba, Cl, Na, Fe, and Sr.

7. The system of claim 4, wherein the sample characteristic is selected from a group consisting of electromagnetic fields, strain, temperature, acoustic vibration, and flow.

8. The system of claim 1, wherein the optical transmission network is arranged in a topology selected from the group consisting of a bidirectional switched bus topology, a unidirectional hybrid bus topology, a bidirectional switched tree topology, and a bidirectional hybrid tree topology.

9. The system of claim 1, wherein the plurality of downhole optical devices each comprise an on-board light source.

10. The system of claim 9, wherein the on-board light source comprises an inline fiber laser.

11. The system of claim 10, wherein a wavelength of light output by the inline fiber laser shifts as a function of strain associated with the inline fiber laser.

12. The system of claim 1, further comprising a light source and a detector communicatively coupled to the plurality of downhole optical devices, wherein the plurality of downhole optical devices are configured to receive light from the light source, modulate the light to form an optical signal with information embedded therein, and transmit the optical signal to the detector.

13. The system of claim 12, further comprising a controller communicatively coupled to the detector, wherein the detector transmits an electronic representation of the optical signal to the controller.

14. The system of claim 13, wherein the controller is configured to:
select one or more particular downhole optical devices among the plurality of downhole optical devices;
transmit a control signal to a particular optical switch among the at least one optical switch, the control signal directing the particular optical switch to route light from the light source towards the one or more particular optical devices; and
receive an electronic representation of the optical signal transmitted by the one or more particular optical devices.

15. The system of claim 14, wherein substantially all of the light from the light source reaches the one or more particular optical devices.

16. The system of claim 15, wherein the control signal comprises at least one of a data signal, a voltage signal, an optical signal, an acoustic signal, and a thermal signal.

17. The system of claim 16, wherein the control signal is an optical signal transmitted to the particular optical switch over the optical transmission network.

18. The system of claim 13, wherein the controller further comprises a modulator, wherein the modulator is an optical modulator configured to modulate light generated by the light source and transmit the modulated light over the optical transmission network.

19. The system of claim 1, wherein the at least one optical switch is disposed within the wellbore.

20. A method for communicating with a plurality of downhole optical devices over an optical transmission network comprising at least one optical switch, the method comprising;
selecting one or more particular downhole optical devices among the plurality of downhole optical devices;
transmitting a control signal to a particular optical switch among the at least one optical switch, the control signal directing the particular optical switch to route light towards the one or more particular optical devices; and
receiving an electronic representation of an optical signal transmitted by the one or more particular optical devices.

21. The method of claim 20, wherein the optical signal has a signal strength that is proportional to an amount of light that reaches the one or more particular optical devices.

22. The method of claim 21, further comprising multiplexing the optical signal transmitted by the one or more particular devices using at least one of frequency division, time division, wavelength division, spatial division, spread spectrum, optical frequency-domain, coherence division multiplexing, and hybrid techniques.

23. The method of claim 22, wherein the hybrid technique is selected from one or more of a group comprising: wavelength division and time division, time division and spread-spectrum, time division with frequency division, time division and optical frequency-domain, spatial division and time division, space division and wavelength division, space division and spread-spectrum, space division and frequency division, and space division and optical frequency-domain.

24. The method of claim 20, wherein the optical signal is modulated by one or more of a group comprising amplitude modulation, frequency modulation, phase modulation, and polarization modulation.
